(19) United States
(12) Patent Application Publication
(10) Pub. No.: US 2007/0011937 A1
(43) Pub. Date: Jan. 18, 2007

(54) Automatic jigging device for fishing

(75) Inventors: Warren Edward Roh, Littleton, CO (US); Eckehart Zimmermann, Monument, CO (US)

Correspondence Address: LAW OFFICE OF DALE B. HALLING, LLC, 655 SOUTHPOINTE CT, SUITE 100, COLORADO SPRINGS, CO, 80906, US

(73) Assignee: Warren Roh

(21) Appl. No.: 11/484,940

(22) Filed: Jul. 12, 2006

Related U.S. Application Data
(60) Provisional application No. 60/699,090, filed on Jul. 14, 2005.

(51) Int. Cl. A01K 91/06

(52) U.S. Cl. 43/19.2

(57) ABSTRACT

An automatic jigging device for fishing has a motor electrically coupled to a power supply. A current detector detects a current used by the motor. A switch, controlled by the current detector, is in series with the motor and the power supply.

### RELATED APPLICATIONS

The present invention claims priority on provisional patent application, Ser. No. 60/699,090, filed on Jul. 14, 2005, entitled “Automatic Fishing Jigger” and is hereby incorporated by reference.

### FIELD OF THE INVENTION

The present invention relates generally to the field of fishing devices and more particularly to an automatic jigging device for fishing.

### BACKGROUND OF THE INVENTION

Fishermen are constantly looking for new ways to optimize the art of catching fish. One method of enticing fish to strike is called jigging. Jigging is the movement of a fishing rod in such a manner as to cause the lure or bait attached at the end of the line to move in such a way as to attract fish and cause them to strike. Dock, ice, boat and bank fisherman often use more than one fishing rod and reel. Since the fisherman can only jig with one or at most, two rods at a time, being able to jig additional rods automatically offers a great advantage. A number of attempts have been made to create an automatic jigging device, but they have all suffered from one deficiency or another. For instance, many of the previous devices require large batteries such as a car battery or they don't alert a user that a fish is on the line and the motor of the device burns out.

Thus there exists a need for an automatic jigging device that does not require large batteries or other electrical power sources and overcomes the other problems of the prior art.

### SUMMARY OF INVENTION

An automatic jigging device for fishing that overcomes these and other problems has a current detector coupled to the motor that jigs the fishing rod holder. The current detector detects when a fish strikes or is on the line, because the motor draws more current due to the additional load. When the current detector detects a strike it triggers an alarm, which may be an audible alarm, visual alarm, a wireless message or some other type of alarm. If a fish is on the line a processor or circuit determines that the current has exceeded a threshold for a period of time and turns off the motor. In one embodiment a second alarm is triggered to differentiate a strike from a fish on the line. After the motor has been off for a period of time, it starts up again. Using this device, the motor is protected from being burned out, the amount of power is reduced and the fisherman is alerted to a strike or when a fish on the line. Because of the reduced power consumption, the device can run for an extended period of time on ordinary AA-cell or other size batteries.

### BRIEF DESCRIPTION OF THE DRAWINGS

FIG. 1 is a top left perspective view of a backside of an automatic jigging device in accordance with one embodiment of the invention;

FIG. 2 is a top left perspective view of a front-side of an automatic jigging device in accordance with one embodiment of the invention;

FIG. 3 is a top right perspective view of a vertical extension of a clamp in accordance with one embodiment of the invention;

FIG. 4 is a top view of a slot in a housing of an automatic jigging device in accordance with one embodiment of the invention;

FIG. 5 is a circuit diagram of the circuit used in an automatic jigging device in accordance with one embodiment of the invention; and

FIG. 6 is a flow chart of the steps used in operating an automatic jigging device in accordance with one embodiment of the invention.

### DETAILED OF THE DRAWINGS

The present invention is related to an automatic jigging device for fishing that alerts a user when there is a strike or when a fish is on the line.

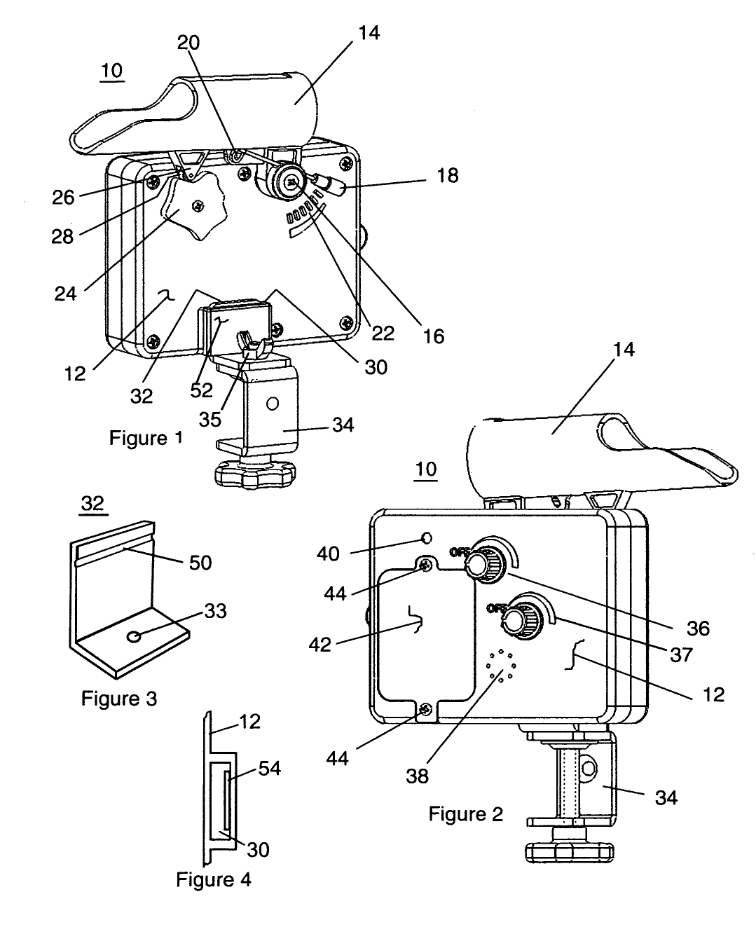

FIG. 1 is a top left perspective view of a backside of an automatic jigging device 10 in accordance with one embodiment of the invention. The device 10 has a housing 12 with a fishing rod holder 14 pivotally 16 connected to the housing 12. An adjustable torsion spring 18 acts as a counter weight for the fishing rod. The torsion spring 18 connects between an eyelet 20 on the fishing rod holder 14 and a plurality of lips 22. A cam 24 is attached to and is rotated by a motor, which is in the housing 12. The cam 24 is in contact with a cam follower 26 on the fishing rod holder 14. The cam follower 26 includes a roller 28 that reduces the friction between the cam 24 and the cam follower 26. The housing 12 has a vertical slot 30 that engages a vertical flange 32 of a clamp 34. The clamp 34 can be mounted to a boat handrail or a pier handrail or a number of other items.

FIG. 2 is a top left perspective view of a front-side of an automatic jigging device 10 in accordance with one embodiment of the invention. The jigging device 10 has a motor speed control 36 and a sensitivity control 37. A speaker 38 alerts the user if a fish strikes their bait or is on the line. The sensitivity control 37 determines how big a strike or fish sets off the alarm. A light 40 may also be used to alert the user if a fish strikes their bait or is on the line. A battery compartment 42 is accessible by removing screws 44 or in one embodiment the screws hold rotatable flanges that are rotated to provide access to the batteries. The batteries provide power for the motor, speaker 38, light 40 and other electronic circuitry.

FIG. 3 is a top right perspective view of a vertical extension 32 of a clamp in accordance with one embodiment of the invention. Vertical extension 32 attaches to clamp 34 with a nut and bolt 35 extending through a corresponding bore 33 in vertical extension 32 and clamp 34. This figure also shows the slot 50 that is used to hold the housing 12 securely to the clamp 34. FIG. 4 is a top view of a slot 30 molded into a housing 12 of an automatic jigging device in accordance with one embodiment of the invention. The flange 54 engages the slot 50 to lock the housing to the clamp 34.

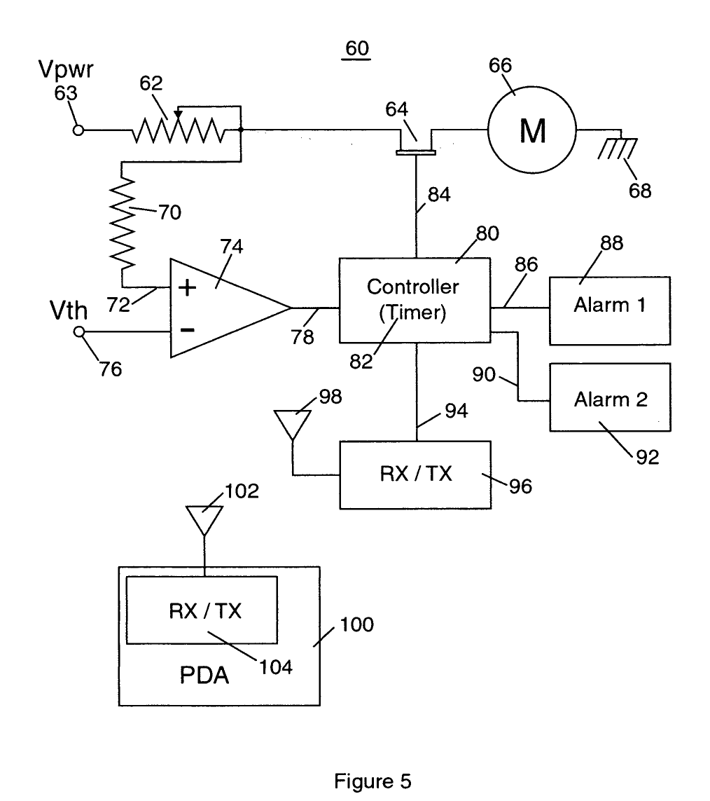

FIG. 5 is a circuit diagram of the circuit 60 used in an automatic jigging device in accordance with one embodiment of the invention. The circuit 60 has a motor control pod 62 shown as a variable resistor. One end of the variable resistor 62 is connected to a power supply 63. The other end is connected to an electronic switch 64, shown as a n-channel MOSFET transistor. However, other controllable switches may be used. The switch 64 is connected to a motor 66 which is connected to ground 68. A terminal of resistor 70 is connected between the resistor 62 and the switch 64. A second terminal of resistor 70 is coupled to a positive 72 input of a comparator 74. The negative input 76 of the comparator 74 is coupled to a threshold voltage 76. The threshold voltage is set by the sensitivity control 37. The output 78 is coupled to a controller 80. The controller 80 includes a timer 82. The controller 80 has an output 84 connected to the control terminal of the controllable switch 64. A second output 86 of the controller 80 is coupled to a first alarm 88. A third output 90 is coupled to a second alarm 92. Note that the first alarm and the second alarm may be a speaker which is driven by a different signal to form the first and second alarm. A fourth output 94 is coupled to an RF transmitter 96 or transceiver. The transmitter/receiver 96 is coupled to an antenna 98. A Personal Digital Assistant (PDA) 100 receives the signal through an antenna 102 coupled to a receiver (transceiver) 104. Note that the PDA could be a cell phone, a computer or any RF device. The PDA 100 can receive the alarm messages from the jigger device 10.

The comparator 74 acts as a current detector. When the motor 66 is stopped it draws considerably more current than when it rotating. As a result, the voltage at the node between the motor 66 and the variable resistor 62 drops. This drop in voltage is detected by the comparator 74 which causes the output 78 to go high. The controller 80 detects this change in the signal. Once the controller 80 has detected the change in the signal 78, it triggers alarm one 88 and may send a message to the PDA 100 using the transmitter 96. In addition, the controller 80 starts a timer 82. If the signal 78 stays high for predetermined period of time, which may be five seconds in one embodiment, the controller 80 triggers the second alarm 92 and may turn off the first alarm 88. The controller 80 may also message the PDA 100. In addition, the controller 80 signals 84 the electronic switch 64 to open, which turns off the motor 66. This saves power and keeps the motor 66 from overheating. This starts a second clock. When the second clock exceeds a certain period of time, which may be 15 seconds in one embodiment, the controller 80 signals the switch 64 to close. This starts the process over. The first alarm 88 tells the user that their fishing pole had a strike. The second alarm 92 tells the user that a fish is on the line. This automatic jigging device alerts the user by a light, audio alarm, spoken word, text message, or graphical user interface, that a fish is on their line, protects the motor and draws less power than prior art devices. As a result, the device only requires normal AA-cells (or similar size) batteries and will operate for many hours on these batteries for hours fishing fun. Note that the device will also run off of other power sources.

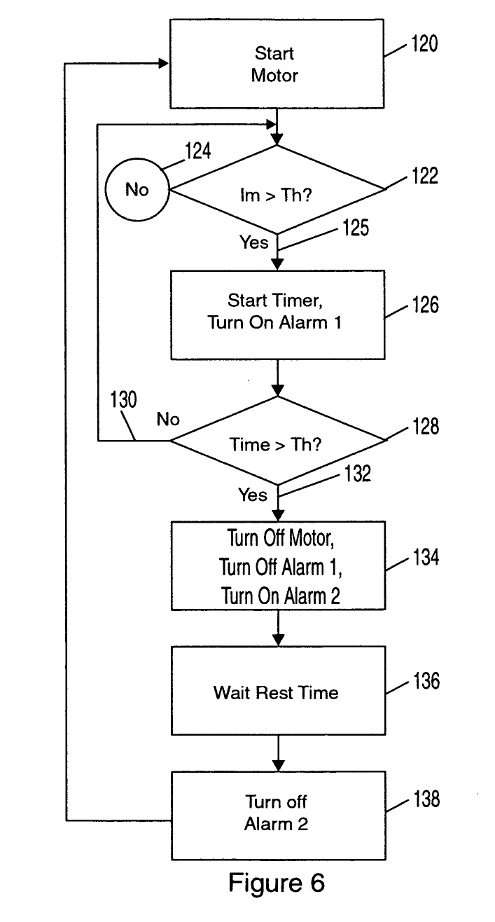

FIG. 6 is a flow chart of the steps used in operating an automatic jigging device in accordance with one embodiment of the invention. The process starts by stating the motor 120. Next it is determined if the motor current (Im) is greater than a threshold (Th) at step 122. If the motor current (Im) is not greater than a threshold 124 the processes continues to check this parameter. When the motor current (Im) is greater than a threshold 125, a timer is started and a first alarm is triggered at step 126. Next, it is determined if the time that that the motor current has exceeded the threshold has exceed a predetermined period of time at step 128. When the time has not exceed a predetermined period of time 130 then the process returns to step 122. When the time has exceed a predetermined period of time 132, the motor and alarm one are turned off and alarm two is triggered at step 134. Next the process waits for a rest period at step 136. Once the rest period is up, alarm two is turned off at step 138. Next, the process returns to step 120 and the motor is turned on.

Thus there has been described an automatic jigging device that alerts the user that a fish is on their line, protects the motor and draws less power than prior art devices. As a result, the device only requires normal AA-cells (or similar size) batteries and will operate for many hours on these batteries for hours fishing fun.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. An automatic jigging device for fishing, comprising:
a motor electrically coupled to a power supply;
a current detector detecting a current used by the motor; and
a switch controlled by the current detector in series with the motor and the power supply.

2. The device of claim 1, further including an alarm controlled by the output of the current detector.

3. The device of claim 2, further including a timer coupled to the output of the current detector.

4. The device of claim 3, further including a RF transmitter controlled by the output of the current detector.

5. The device of claim 3, further including a cam coupled to the motor.

6. The device of claim 5, further including a rod holder having a cam follower arm in contact with the cam.

7. A method of operating an automatic jigging device, comprising the steps of:
a) jigging a fishing rod holder;
b) determining if a force applied to a cam follower of the fishing rod holder exceeds a predetermined force; and
c) when the force applied to the cam follower of the fishing rod holder exceeds the predetermined force, triggering an alarm.

8. The method of claim 7, further including the steps of:
d) determining if the force applied to the cam follower of the fishing rod holder exceeds the predetermined force for a predetermined period of time;
e) when the force applied to the cam follower of the fishing rod holder exceeds the predetermined force for the predetermined period of time, turning off a motor driving the cam follower.

9. The method of claim 8, further including the step of:
f) triggering a second alarm.

10. The method of claim 8, further including the steps of:
f) when the motor has been off for a second predetermined period of time, restarting the motor; and
g) repeating steps b-f.

11. The method of claim 7, wherein step (b) further includes the step of:
b1) determining if a current to a motor driving the cam follower exceeds a predetermined current.

12. The method of claim 8, further including the step of:
f) when the force applied to the cam follower of the fishing rod holder does not exceed the predetermined force for the predetermined period of time, returning to step (b).

13. The method of claim 10, wherein step (f) further includes the step of:
f1) turning off the second alarm.

14. An automatic jigging device for fishing, comprising:
a housing having pivotally connected to a fishing rod holder;
a motor in the housing turning a cam; and
a current detector detecting a current used by the motor.

15. The device of claim 14, wherein an output of the current detector controls an alarm.

16. The device of claim 15, further including a switch in series with the motor and controlled by the current detector.

17. The device of claim 16, wherein the housing has a mounting slot with a flange.

18. The device of claim 17, further including a clamp with a vertical extension that mates with the mounting slot and the vertical extension includes a solt that engages the flange.

19. The device of claim 18, further including a RF transmitter triggered by the output of the current detector.

20. The device of claim 14, further including a sensitivity control that sets a threshold for the current detector.
